(19) United States
(12) Patent Application Publication
(10) Pub. No.: US 2013/0161336 A1
(43) Pub. Date: Jun. 27, 2013

(54) Laminated Cookware Having Microscopic And Macroscopic Clad Constructions

(71) Applicant: MEYER INTELLECTUAL PROPERTIES LTD., Kowloon (CN)

(72) Inventor: Matthew Sakae Forkin, San Mateo, CA (US)

(73) Assignee: MEYER INTELLECTUAL PROPERTIES LTD., Kowloon (CN)

(21) Appl. No.: 13/721,492

(22) Filed: Dec. 20, 2012

Related U.S. Application Data
(60) Provisional application No. 61/580,494, filed on Dec. 27, 2011.

(51) Int. Cl. A47J 36/02

(52) U.S. Cl. CPC A47J 36/02
USPC 220/573.1; 29/557

(57) ABSTRACT

An article of cookware has a laminated construction in which at least one core macroscopic layer, which be of a laminate or clad construction is surrounded by a covering macroscopic layer that extends over the inner and outer surface of the cookware body, including the rim where the inner and outer surface meet. This covering layer is in turn covered or surround by one or more thin film layers or microscopic thickness.

### CROSS REFERENCE TO RELATED APPLICATIONS

The present application claims the benefit of priority to the U.S. Provisional Patent Application of the same title that was filed on Dec. 27, 2012, having application Ser. No. 61/580,494, which is incorporated herein by reference.

### BACKGROUND OF INVENTION

The present invention relates to a cookware article, and in particular to pots and pans having a clad construction of multiple metal layers of macroscopic thickness (0.1-5 mm) coating with thin film coating thinner than 0.1 mm

The application of hard, durable, inert, and non food residue retaining (non-stick) thin film coatings for cookware has been suggested in many patents, though no products have been successfull commercially. Such coatings include metals, oxides, nitrides, carbides, carbo-nitrides and diamond like carbon coatings.

While such cookware can be fabricated from monolithic metals before coating, it would also be desirable to apply such thin film coatings to cookware having a clad construction in which multiple macroscopic layers of metal are joined in sheets prior to metal forming.

It is therefore a first object of the present invention to provide clad metal cookware having uniform continuous and adherent thin film coatings.

### SUMMARY OF INVENTION

In the present invention, the first object is achieved by providing an article of cookware, comprising a substantially horizontal bottom, substantially upright sidewall extending upward from and encircling said bottom to form a rim, with a fluid retaining interior volume below the rim, wherein said sides and bottom are formed of: a first metal core having a macroscopic thickness, at least one first surrounding covering layer of metal over the first metal core, at the bottom, sides and rim of the vessel, a microscopic thin film coating surrounding the first surrounding covering layer of metal at the bottom, sides and rim of the vessel.

A second aspect of the invention is characterized by such an article of cookware wherein the thin film layers is selected from the group consisting of a metal nitride, metal carbide, metal carbo-nitride, carbon compound and carbon.

Another aspect of the invention is characterized by such an article of cookware wherein the first surrounding covering layer of metal is stainless steel.

Another aspect of the invention is characterized by such an article of cookware wherein the first surrounding covering layer of metal is selected from the group consisting of chromium compounds and nickel compounds.

Another aspect of the invention is characterized by such an article of cookware wherein the first surrounding covering layer of stainless steel is formed by at least one of welding and crimping the stainless steel layers that formed an external cladding on opposing sides of the first metal core.

Another aspect of the invention is characterized by such an article of cookware wherein the first metal core comprises at least one layer of a metal selected from the group consisting of copper and aluminum.

The above and other objects, effects, features, and advantages of the present invention will become more apparent from the following description of the embodiments thereof taken in conjunction with the accompanying drawings.

### BRIEF DESCRIPTION OF DRAWINGS

FIG. 1A-C is a cross-sectional elevation of a cookware vessel having a macroscopic and microscopic clad construction.

FIG. 2A-2E are cross-sectional elevations of a series of steps used to form the rim portion of the cookware vessel prior to layers prior to depositing at least one microscopic outer covering layer.

FIG. 3A-3F are cross-sectional elevations of the edge of a clad cookware vessel showing a sequence of step in a process for sealing the edge of the macroscopic clad layers prior to depositing at least one microscopic outer covering layer.

FIG. 4A-G is a cross-sectional elevation illustrating an alternative process of forming the cookware vessel in FIG. 4A, which has a layered construction that includes at least one microscopic outer covering layer.

### DETAILED DESCRIPTION

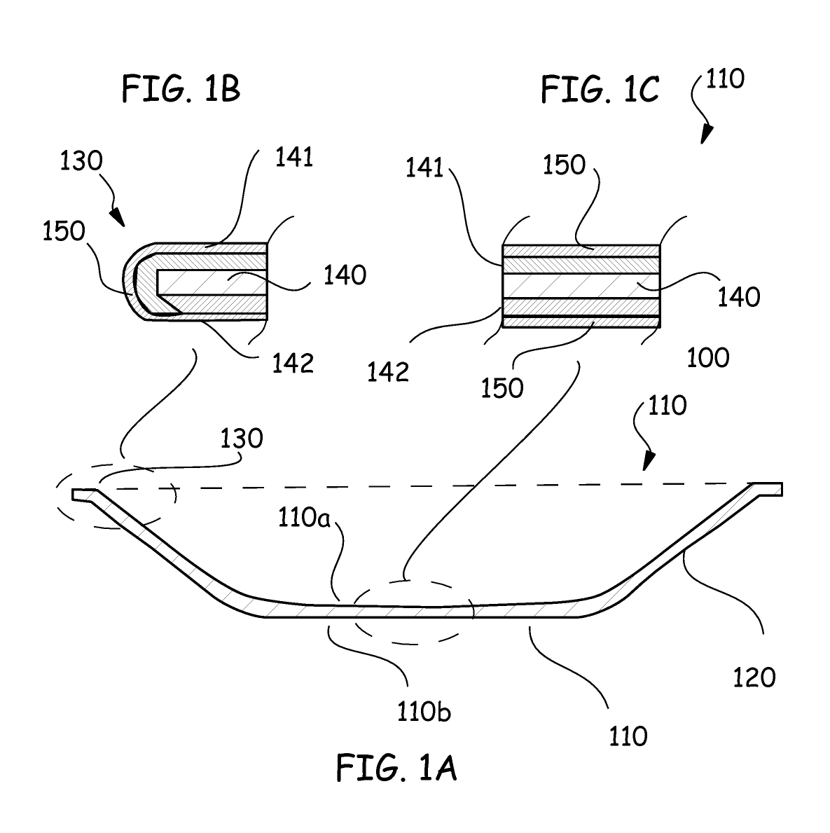

Referring to FIGS. 1 through 4 wherein like reference numerals refer to like components in the various views, there is illustrated therein a new and improved laminated cookware having microscopic and macroscopic clad constructions, generally denominated 100 herein.

Cookware articles, particularly cookware vessels deploying clad constructions are well known for several benefits. Primarily the outer layer of the construction confers durability to avoid damage from the foodstuff or cleaning process, and/or chemical inertness to foodstuffs. The inner layers aid in the transmission and spreading of heat from the heating source on the external bottom surface of the cookware, to the cooking surface on the interior and more particularly the interior bottom cooking surface.

Such clad cookware articles are generally fabricated from clad metal sheets, formed by a myriad of possible lamination processes, but general deploying macroscopic or visible sheet of different materials, ranging in thickness from several mm's to about 0.25 mm per layer. A common construction uses copper, aluminum and alloys thereof as a core material, which is covered on the top and bottom by stainless steel, having at least 3 layers in total. Alternatively, a core layer of copper or an alloy thereof may be covered by aluminum or aluminum layer layers on opposing sides, and the aluminum/aluminum alloy layers then covered by stainless steel layers. Alternatively, the core layer can be an iron or mild steel, which is covered with stainless steel.

It has also been suggested that cookware can deploy various constructions but be coated by one or more microscopic outer layers, that are hard and inert, particularly metal and carbon compounds, and more particularly metal nitrides, metal carbides, metal carbon-nitrides, and pure and nearly pure carbon, such as diamond like carbon, and carbon compounds. Such microscopic layers being hard and brittle, must be applied after the vessel or cookware article is formed by the drawing of flat metal stock, these microscopic layers typically being applied by physical or chemical vapor deposition. Though such physical and chemical vapor deposition processes have low deposition rates, the coatings need only be microscopic, that is with a thicknesses of less than about 100 microns (0.1 mm), but more typically 0.1 to 10 microns to provide superior surface properties. Though titanium nitride has been used on bakeware and knives, to date no cookware vessels intended to be exposed to direct high heat have commercialized. Alternative thin films to titanium nitride include titanium aluminum nitride, titanium chromium nitride, aluminum nitride chromium aluminum nitride, as well as nitrides or carbo-nitrides of at least one element from Groups 4, 5, or 6, Al or B. Methods of depositing such coatings have been described in the following U.S. Pat. Nos. 5,447,803; 6,197,438; 6,399,219; 6,906,295, 6,942,935; 7,462,375; and 8,201,768, all of which are incorporated herein by reference.

It has been discovered that clad metal cookware is difficult to properly vacuum coat with uniform coatings. In particular a clad metal construction of an aluminum core covered by an upper and lower stainless steel layers was formed into a cookware article having a bottom, and generally upright surrounding sidewalls that terminate in an upper rim to define a vessel capable of retaining fluid. In forming such a vessel the upper rim is trimmed to a uniform height after forming by deep drawing, exposing the core aluminum layer and the interfaces therewith that are bonded to the stainless steel layers. However, even if the vessel can be formed of a disk of clad metal without subsequent trimming, the interfaces between the clad metal layers at the edge of the disk would be exposed.

While it is possible to coat such an article directly in a vacuum chamber with the above thin film coating, the coating did not uniformly cover or seal the exposed aluminum at the trimmed rim. The rim region has variations in color and coating coverage, which appear as stains both on the rim and inner and outer side walls of the vessel adjacent to the rim.

While there are multiple possible causes for this phenomena, which is currently at best poorly understood, it has been discovered that a uniform appearing microscopic coating can be deposited when the interfaces between the macroscopic clad layers, that is in this example the aluminum and stainless steel layers, do not extend to the rim. That is in a clad construction, the outer macroscopic cladding layer should substantially surround the inner cladding layers locating between the outer and inner clad layers of the sheet used to form the cookware body.

In accordance with the present invention, the clad metal cookware article has an edge that is sealed to eliminate the potential for outgassing between clad layers during vacuum coating. Alternatively, the clad construction may have a single or clad core layer of one or more metal layers, which is covered by a surrounding electroplated covering layers, which is turn is covered by a thin film vacuum deposited hard, abrasion resistant compound.

This construction is illustrated in detail in FIG. 1A-C, in which the cookware, illustrated as a vessel 100, capable of retaining a fluid, has a bottom cooking surface 110, surrounding by attached and substantially upward extending surrounding sidewall 120, which terminate at an upper rim 130. Hence, inner bottom surface 110a is the inner cooking surface which contacts foodstuffs, and outer surface bottom surface 11b is the heat source contacting surface.

The vessel 100 in FIG. 1A has at least one inner clad layer 140, covered by an upper outer clad layer 141 and a lower outer clad layer 142. Layers 140, 141, 142 and any intervening layers between 140-141, and 140-142, are macroscopic, that is a thickness of at least about 0.25-0.4 mm, but more preferably at least about 0.5 mm, with the inner or core clad layer 140 likely to be 1-3 mm thick.

FIG. 1B and 1C show that at least one of the outer clad layers 141 or 142 extends around the rim 130 to meet the other outer clad layer and cover the interfaces between layers 140-141 and 140-142, as well as an internal interface of layer 140, if it includes more than one layer. The thin film microscopic layer (s) 150 is deposited on outer layers 141 and 142, and thus likewise extends around the outer clad layers.

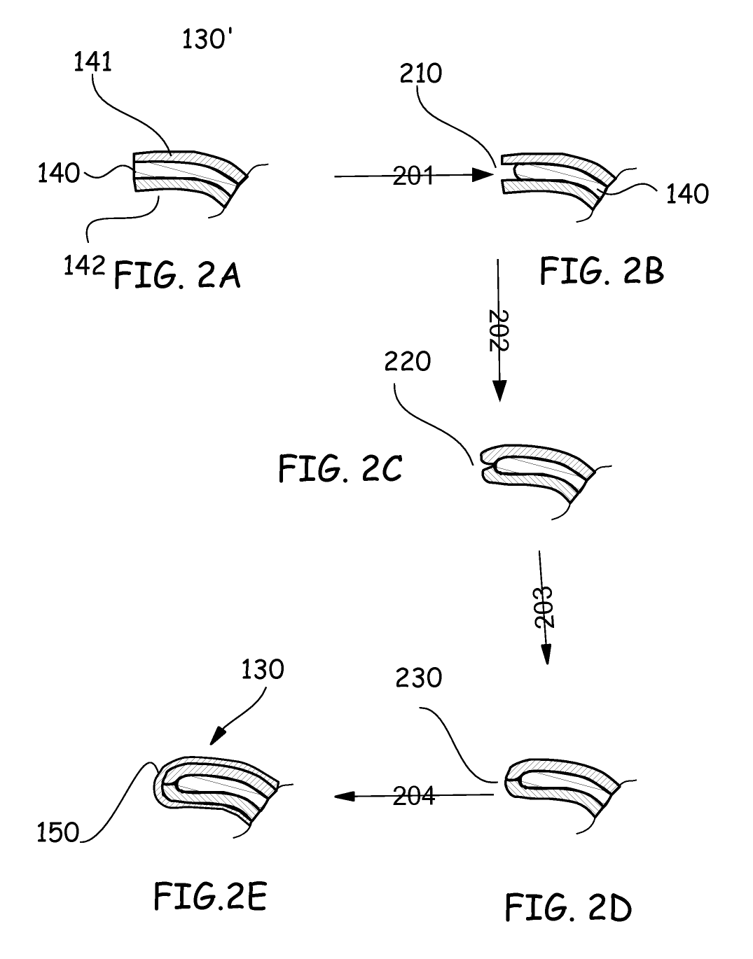

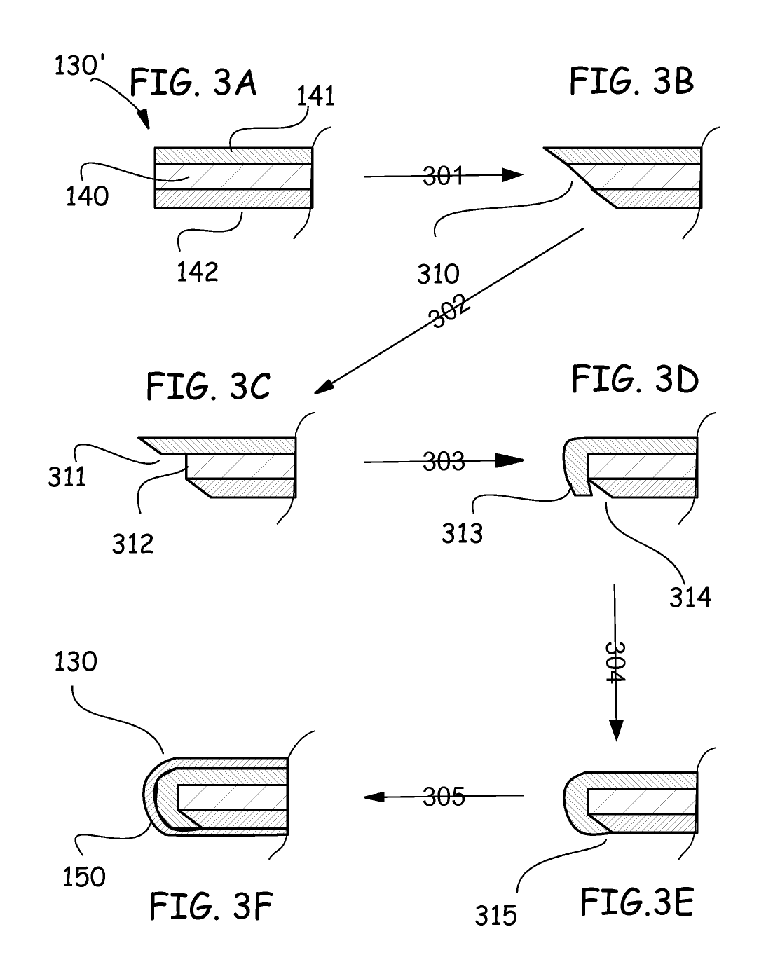

The interface cannot be completely eliminated by merely folding or rolling the edge, although this may make the defects less visible, as shown in the alternative embodiments of FIG. 2A-D, and FIG. 3A-F. Such sealing is achieved by different means as described below.

It has been discovered that the detrimental effect of the exposed clad metal interfaces can be sufficiently eliminated by partially trimming the cladding at the rim so the outer layer on the top or interior cooking surface can be folded to meet the outer cladding on the bottom or exterior of the vessel as shown in FIG. 2A-2C, as further described below:

The edge of the rim 130′ in FIG. 2A is illustrated after conventional trimming to remove height variations from the forming process. In should be appreciated that in the processes described below, the normal trimming that occurs after metal deformation may in some instances be combined with the step of removing core material or angle trimming the rim to facilitate such removal and a subsequently rolling and crimping an extending outer metal layer on one side of the pan to the metal outer layer on the other side. That is, the trimming need not be completed around the entire rim before angle trimming, or removal of core material. Alternatively, these steps may be carried out simultaneously around the entire rim. Further, additional shaping of the rim may occur before or after these steps to modify the profile created in the deep drawing. Such additional shaping steps include, without limitation, forming one or more pouring spouts, blanking, and trimming.

In step 201, the results of which are shown in FIG. 2B, a portion of the inner clad layer(s) 140 has been removing by machining to prepare for the folding of the extending edges of outer cladding layers 141 and 142, over edge cavity 210. In step 202, extending edges of outer cladding layers 141 and 142 are folded to meet each seam 220 substantially closing cavity 210. In step 203, outer cladding layers 141 and 142 at seam 220 are welded together to form closed seam 230. In step 204, microscopic coating 150 is deposited over outer cladding 141, 142 and the welded seam region 230. It should be understood that additional intermediate steps of polishing, washing and cleaning would be used prior to vacuum coating. The processes illustrated in FIG. 3A-E and FIG. 2A-E, could be performed with crimping and/or welding.

FIG. 3A-G illustrates an alternative sealing process that avoids welding by a crimping process, which preferably also includes an initial step of tight rolling to of one layer over the core to bring the outer or upper clad layer 141 to lower clad layer 142 prior to crimp to avoid forming a cavity between the crimped layers and the core.

The edge of the rim 130′ in FIG. 3A is illustrated after conventional trimming to remove height variations from the forming process. Step 301 is angle cutting the edge to form angled edge 310. In step 302, a portion of core clad layer(s) 140 is removed to leave a square step 312 in edge 310, which partially upper cuts the edge of upper outer layer 141 leaving overhanging portion thereof 311.

In step 303, this overhanging portion 311 is folded over core clad layer(s) 140 resulting in lateral edge 313 formed of the outer layer 141, which almost reaches the lower clad layer 142, which can result in a slight lower cavity 314.

This slight lower cavity 314 is eliminated in step 304 by crimping at least a portion of edge 313. In step 305, microscopic coating 150 is deposited over outer cladding 141, 142 and the junction at the crimped seam region 315.

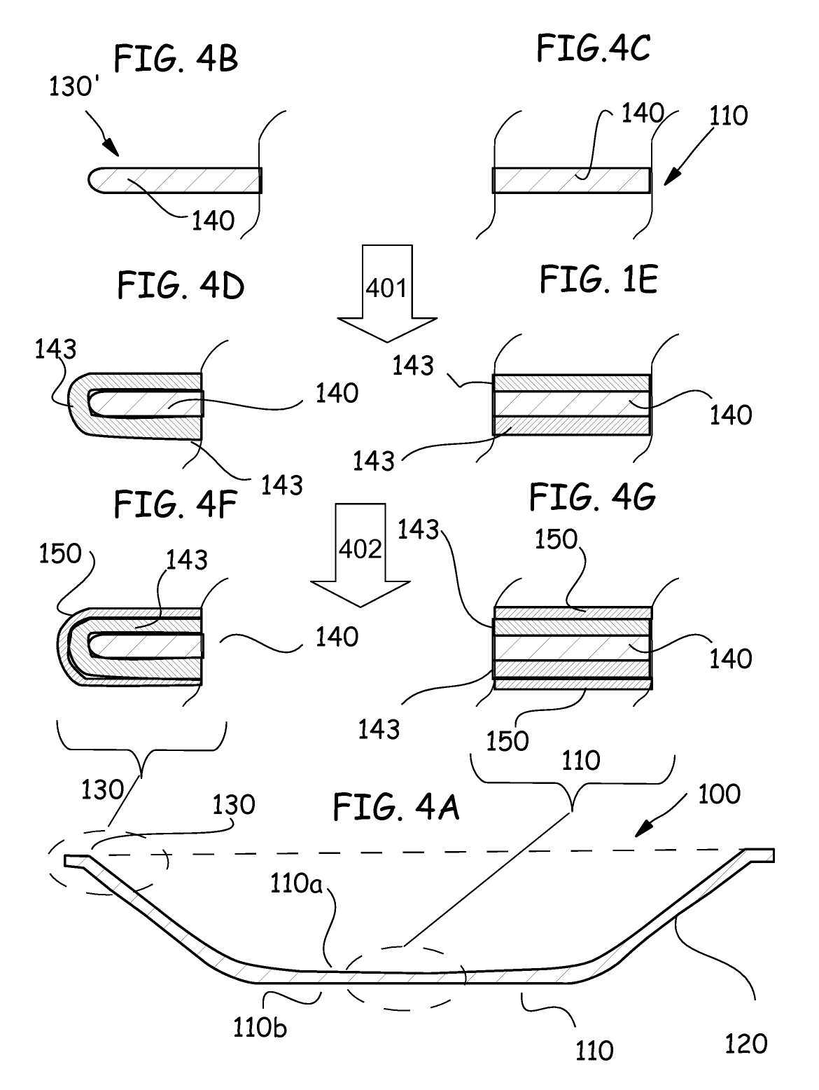

In another embodiment of the invention illustrated in FIG. 4A-4G. a solid or clad cover layer 140 forming the pan body is coated with a single or multiple conforming surrounding outer layers by plating in step 401, forming surrounding layer 143, sealing any potential interfaces with and between the core clad layer 140 and other layers. In step 402, microscopic coating 150 is deposited over outer cladding 143.

Surrounding layer 143 can be applied by electroplating or electroless coating, and may consist of chromium, nickel, alloys thereof and the like, and depending on the coating thickness can be considered to be microscopic or macroscopic in dimensions. In particular, both boron and phosphorus doped electroless nickel can be applied over a cookware article formed of a single or clad core metal layer before the deposition of thin film coatings in vacuum by physical or chemical vapor depositions. Such electroplating or electroless deposition can be particularly attractive for depositing a relatively hard metal over a softer metal such as copper or aluminum, including alloys thereof, prior to depositing the above compounds and carbon as thin films.

While the invention has been described in connection with a preferred embodiment, it is not intended to limit the scope of the invention to the particular form set forth, but on the contrary, it is intended to cover such alternatives, modifications, and equivalents as may be within the spirit and scope of the invention as defined by the appended claims.

I claim:

1. An article of cookware, comprising:
a) a substantially horizontal bottom,
b) substantially upright sidewall extending upward from and encircling said bottom to form a rim, with a fluid retaining interior volume below the rim ,
c) wherein said sides and bottom are formed of:
i) a first metal core having a macroscopic thickness,
ii) at least one first surrounding covering layer of metal over the first metal core, at the bottom, sides and rim of the vessel,
iii) a microscopic thin film coating surrounding the first surrounding covering layer of metal at the bottom, sides and rim of the vessel.

2. An article of cookware according to claim 1 wherein the thin film layers is selected from the group consisting of a metal nitride, metal carbide, metal carbo-nitride, carbon compound and carbon.

3. An article of cookware according to claim 2 wherein the first surrounding covering layer of metal is stainless steel.

4. An article of cookware according to claim 2 wherein the first surrounding covering layer of metal is selected from the group consisting of chromium compounds and nickel compounds.

5. An article of cookware according to claim 3 wherein the first surrounding covering layer of stainless steel is formed by at least one of welding and crimping the stainless steel layers that formed an external cladding on opposing sides of the first metal core.

6. An article of cookware according to claim 5 wherein the first metal core comprises at least one layer of a metal selected from the group consisting of copper, aluminum, carbon-steel, and alloys thereof

7. An article of cookware according to claim 2 wherein the first metal core having a macroscopic thickness is at least one of copper, aluminum, carbon-steel and alloys thereof, and the at least one first surrounding covering layer of metal is a plated metal layer.

8. An article of cookware according to claim 7 wherein the at least one first surrounding covering layer of metal is a plated nickel or chromium alloy.

9. A method of forming an article of cookware, the method comprising:
a) providing a clad metal laminate having at least one core metal layer, an upper metal layer bonded to and covering a first outer surface of the least one core metal layer and a lower metal layer bonded to and covering a second outer surface of the least one core metal layer that is opposite the first outer surface,
b) drawing the clad metal laminate to form a vessel capable of retaining a fluid, the vessel having a bottom surface that is surrounded by attached substantially upright surrounding walls,
c) trimming off an upper portion of the surrounding upright walls to provide a rim to the vessel, wherein said step of trimming initially exposes the layers in the clad metal laminate,
d) sealing exposed interfaces between metal layers in the clad metal laminate at the trimmed rim,
e) vapor depositing one or more thin film layers on at least the macroscopic covering of the rim.

10. The method of forming an article of cookware according to claim 9 wherein said step of sealing exposed interfaces between metal layers in the clad metal laminate at the trimmed rim further comprises the steps of tight rolling and crimping.

11. The method of forming an article of cookware according to claim 9 wherein said step of sealing exposed interfaces between metal layers in the clad metal laminate at the trimmed rim further comprises plating of an additional metal layer on the rim.

12. The method of forming an article of cookware according to claim 9 wherein said step of sealing exposed interfaces between metal layers in the clad metal laminate at the trimmed rim further comprises welding the upper metal layer to the lower metal layer.

13. The method of forming an article of cookware according to claim 10 wherein said steps of tight rolling and crimping comprise:
a) removing a portion of the at least one core metal layer at the trimmed rim to provide an overhanging portion of at least one of the upper and lower metal layer,
b) folding over the overlapping portion of at least one of the upper and lower metal layer to reach the other metal layer,
c) crimping the first and second metal layers to seal to each other.

14. The method of forming an article of cookware according to claim 13 further comprising a step of angle trimming the rim before said step of removing a portion of the at least one core metal layer at the trimmed rim to provide an overhanging portion of at least one of the upper and lower metal layer.

15. The method of forming an article of cookware according to claim 12 wherein said step of sealing exposed interfaces between metal layers in the clad metal laminate at the trimmed rim further comprises:
a) removing a portion of the at least one core metal layer at the trimmed rim to provide an overhanging portion of at least one of the upper and lower metal layer,
b) folding over the overlapping portion of at least one of the upper and lower metal layer to reach the other metal layer, and then welding adjacent portion of the first and second metal layers to seal to each other.

16. A method of forming an article of cookware, the method comprising:
a) providing a clad metal laminate having at least one core metal layer, an upper metal layer bonded to and covering a first outer surface of the least one core metal layer and a lower metal layer bonded to and covering a second outer surface of the least one core metal layer that is opposite the first outer surface,
b) drawing the clad metal laminate to form a vessel capable of retaining a fluid, the vessel having a bottom surface that is surrounded by attached substantially upright surrounding walls,
c) trimming off an upper portion of the surrounding upright walls to provide a rim to the vessel, wherein said step of trimming initially exposes the layers in the clad metal laminate,
d) a step for sealing exposed interfaces between metal layers in the clad metal laminate at the trimmed rim,
e) vapor depositing one or more thin film layers on at least the macroscopic covering of the rim.

17. The method of forming an article of cookware according to claim 16 wherein said step of sealing exposed interfaces between metal layers in the clad metal laminate at the trimmed rim is selected from the group consisting of metal plating, welding and crimping.

18. The method of forming an article of cookware according to claim 16 wherein said step for sealing exposed interfaces between metal layers in the clad metal laminate at the trimmed rim further comprises:
a) removing a portion of the at least one core metal layer at the trimmed rim to provide an overhanging portion of at least one of the upper and lower metal layer,
b) folding over the overlapping portion of at least one of the upper and lower metal layer to reach the other metal layer, and attaching adjacent portion of the first and second metal layers to seal to each other.
c) The method of forming an article of cookware according to claim 18 wherein said step of attaching adjacent portion of the first and second metal layers to seal to each other is selected from the group consisting of welding and crimping.

19. The method of forming an article of cookware according to claim 18 wherein the step of removing a portion of the at least one core metal layer at the trimmed rim to provide an overhanging portion of at least one of the upper and lower metal layer comprises angle trimming.

20. The method of forming an article of cookware according to claim The method of forming an article of cookware according to claim 16 wherein at least one core metal layer comprise aluminum or alloys thereof and the upper and lower metal layers are stainless steel.
